(19) United States
(12) Patent Application Publication
(10) Pub. No.: US 2013/0278540 A1
(43) Pub. Date: Oct. 24, 2013

(54) Inter Touch Sensor Communications

(71) Applicant: Esat Yilmaz, Santa Cruz, CA (US)

(72) Inventor: Esat Yilmaz, Santa Cruz, CA (US)

(21) Appl. No.: 13/452,115

(22) Filed: Apr. 20, 2012

(51) Int. Cl. G06F 3/044; H04L 27/00

(52) U.S. Cl. 345/174; 375/259

(57) ABSTRACT

In one embodiment, a method of communicating between a first touch sensor and a second touch sensor includes listening, by the first touch sensor, for a synchronization signal transmitted by the second touch sensor, the listening comprising detecting capacitance changes at one or more of a plurality of touch electrodes of the first touch sensor. The method further includes establishing a communications session between the first and second touch sensors after the first touch sensor receives the synchronization signal and transmitting data, by the first touch sensor using one or more of the plurality of touch electrodes of the first touch sensor, to the second touch sensor after establishing the communications session.

### TECHNICAL FIELD

This disclosure generally relates to touch sensors.

### BACKGROUND

A touch sensor detects the presence and location of a touch or the proximity of an object (such as a user's finger or a stylus) within a touch-sensitive area of the touch sensor overlaid, for example, on a display screen. In a touch-sensitive-display application, the touch sensor enables a user to interact directly with what is displayed on the screen, rather than indirectly with a mouse or touchpad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are different types of touch sensors, such as (for example) resistive touch screens, surface acoustic wave touch screens, capacitive touch screens, infrared touch screens, and optical touch screens. Herein, reference to a touch sensor encompasses a touch screen, and vice versa, where appropriate. A capacitive touch screen may include an insulator coated with a substantially transparent conductor in a particular pattern. When an object touches or comes within proximity of the surface of the capacitive touch screen, a change in capacitance occurs within the touch screen at the location of the touch or proximity. A controller processes the change in capacitance to determine the touch position(s) on the touch screen.

### BRIEF DESCRIPTION OF THE DRAWINGS

FIG. 1 illustrates an example touch sensor, according to certain embodiments;

FIG. 2 illustrates an example device that utilizes the touch sensor of FIG. 1, according to certain embodiments;

FIG. 3 illustrates an example embodiment of the touch sensor of FIG. 1, according to certain embodiments;

FIG. 4 illustrates another example embodiment of the touch sensor of FIG. 1, according to certain embodiments;

FIG. 5 illustrates communications between two touch sensors of FIG. 1, according to certain embodiments;

FIG. 6 illustrates two devices of FIG. 2 communicating using two touch sensors of FIG. 1, according to certain embodiments; and

FIG. 7 illustrates an example method that is used in certain embodiments to provide communications between two touch sensors, according to certain embodiments.

### DESCRIPTION OF EXAMPLE EMBODIMENTS

A touch sensor may be utilized by any device such as a tablet computer, personal digital assistant (PDA), smartphone, portable media player, and the like to detect the presence and location of a touch or the proximity of an object (such as a user's finger or a stylus) to the device. Typically, devices having touch sensors must be physically connected via a cable or must have a dedicated transceiver (i.e., a Wi-Fi transceiver) in order to transmit and receive data. Transmitting and receiving data on devices via cables or via dedicated transceivers, however, is often cumbersome, is not intuitive, and in most cases adds increased costs, complexity, and weight to the device.

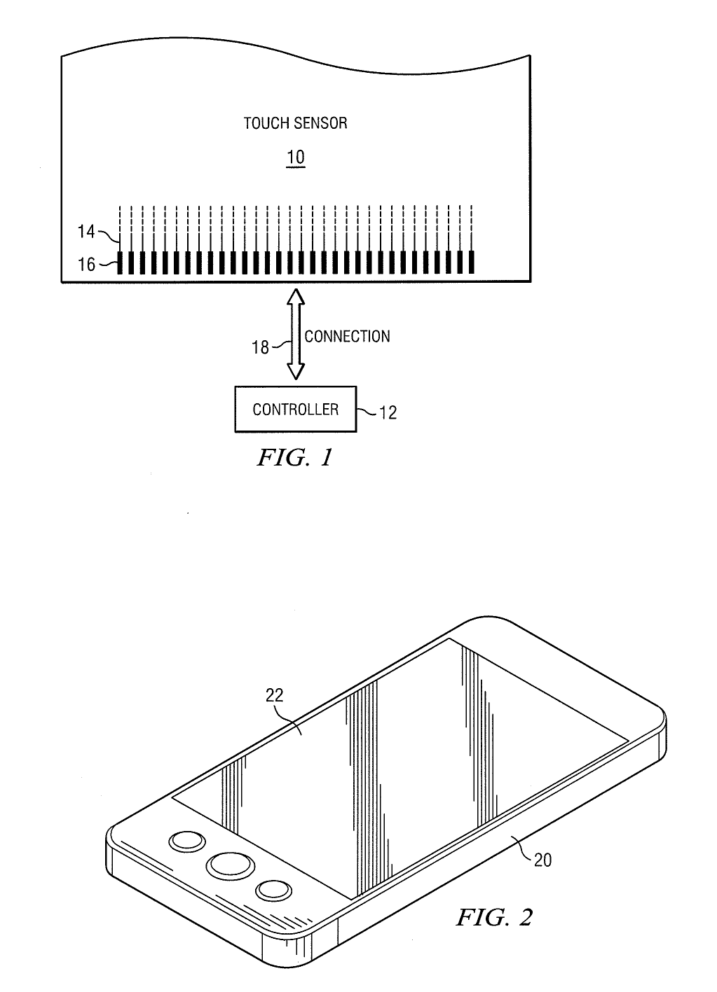

The teachings of the disclosure recognize that it would be desirable for a touch sensor to provide communications to devices by utilizing the touch sensor's drive and sense electrodes. FIG. 1 through 7 below illustrate a touch sensor that provides communication capabilities according to the teachings of the disclosure.

FIG. 1 illustrates an example touch sensor 10 with an example controller 12. Herein, reference to a touch sensor may encompass a touch screen, and vice versa, where appropriate. Touch sensor 10 and controller 12 detect the presence and location of a touch or the proximity of an object within a touch-sensitive area of touch sensor 10. Herein, reference to a touch sensor encompasses both the touch sensor and its controller, where appropriate. Similarly, reference to a controller encompasses both the controller and its touch sensor, where appropriate. Touch sensor 10 includes one or more touch-sensitive areas, where appropriate. Touch sensor 10 includes an array of touch electrodes (i.e., drive and/or sense electrodes) disposed on a substrate, which in some embodiments is a dielectric material.

In certain embodiments, one or more portions of the substrate of touch sensor 10 are made of polyethylene terephthalate (PET) or another suitable material. This disclosure contemplates any suitable substrate with any suitable portions made of any suitable material. In particular embodiments, the drive or sense electrodes in touch sensor 10 are made of indium tin oxide (ITO) in whole or in part. In particular embodiments, the drive or sense electrodes in touch sensor 10 are made of fine lines of metal or other conductive material. As an example and not by way of limitation, one or more portions of the conductive material are copper or copper-based and have a thickness of approximately 5 μm or less and a width of approximately 10 μm or less. As another example, one or more portions of the conductive material are silver or silver-based and similarly have a thickness of approximately 5 μm or less and a width of approximately 10 μm or less. This disclosure contemplates any suitable electrodes made of any suitable material.

In certain embodiments, touch sensor 10 implements a capacitive form of touch sensing. In a mutual-capacitance implementation, touch sensor 10 includes an array of drive and sense electrodes forming an array of capacitive nodes. In certain embodiments, a drive electrode and a sense electrode form a capacitive node. The drive and sense electrodes forming the capacitive node come near each other, but do not make electrical contact with each other. Instead, the drive and sense electrodes are capacitively coupled to each other across a gap between them. A pulsed or alternating voltage applied to the drive electrode (i.e., by controller 12) induces a charge on the sense electrode, and the amount of charge induced is susceptible to external influence (such as a touch or the proximity of an object). When an object touches or comes within proximity of the capacitive node, a change in capacitance occurs at the capacitive node and controller 12 measures the change in capacitance. By measuring changes in capacitance throughout the array, controller 12 determines the position of the touch or proximity within the touch-sensitive area(s) of touch sensor 10.

In particular embodiments, one or more drive electrodes together form a drive line running horizontally or vertically or in any suitable orientation. Similarly, one or more sense electrodes together form a sense line running horizontally or vertically or in any suitable orientation. In particular embodiments, drive lines run substantially perpendicular to sense lines. Herein, reference to a drive line encompasses one or more drive electrodes making up the drive line, and vice versa, where appropriate. Similarly, reference to a sense line encompasses one or more sense electrodes making up the sense line, and vice versa, where appropriate.

In certain embodiments, touch sensor 10 has a single-layer mutual capacitance configuration, with drive and sense electrodes disposed in a pattern on one side of a substrate. In such a configuration, a pair of drive and sense electrodes capacitively coupled to each other across a space between them forms a capacitive node. In a configuration for a self-capacitance implementation, as illustrated in FIG. 4, electrodes of only a single type (e.g. sense) are disposed in a pattern on the substrate. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Controller 12 is operable to detect and process the change in capacitance to determine the presence and location of the touch or proximity input. Certain embodiments if controller 12 communicate information about the touch or proximity input to one or more other components (such one or more central processing units (CPUs) or digital signal processors (DSPs)) of a device that includes touch sensor 10 and controller 12, which may respond to the touch or proximity input by initiating a function of the device (or an application running on the device) associated with it. Although this disclosure describes a particular controller having particular functionality with respect to a particular device and a particular touch sensor, this disclosure contemplates any suitable controller having any suitable functionality with respect to any suitable device and any suitable touch sensor.

In certain embodiments, controller 12 is one or more integrated circuits (ICs)—such as for example general-purpose microprocessors, microcontrollers, programmable logic devices or arrays, and application-specific ICs (ASICs). In some embodiments, controller 12 is coupled to a flexible printed circuit (FPC) bonded to the substrate of touch sensor 10, as described below. Certain embodiments of controller 12 include a processor unit, a drive unit, a sense unit, and a storage unit. The drive unit supplies drive signals to the drive electrodes of touch sensor 10. The sense unit senses charge at the capacitive nodes of touch sensor 10 and provides measurement signals to the processor unit representing capacitances at the capacitive nodes. The processor unit controls the supply of drive signals to the drive electrodes by the drive unit and process measurement signals from the sense unit to detect and process the presence and location of a touch or proximity input within the touch-sensitive area(s) of touch sensor 10. The processor unit also tracks changes in the position of a touch or proximity input within the touch-sensitive area(s) of touch sensor 10. The storage unit, which includes one or more memory devices, stores programming for execution by the processor unit, including programming for controlling the drive unit to supply drive signals to the drive electrodes, programming for processing measurement signals from the sense unit, and other suitable programming, where appropriate. Although this disclosure describes a particular controller having a particular implementation with particular components, this disclosure contemplates any suitable controller having any suitable implementation with any suitable components.

Tracks 14 of conductive material disposed on the substrate of touch sensor 10 couple the drive or sense electrodes of touch sensor 10 to connection pads 16, also disposed on the substrate of touch sensor 10. As described below, connection pads 16 facilitate coupling of tracks 14 to controller 12. In certain embodiments, tracks 14 extend into or around (e.g. at the edges of) the touch-sensitive area(s) of touch sensor 10. Particular tracks 14 provide drive connections for coupling controller 12 to drive electrodes of touch sensor 10, through which the drive unit of controller 12 supplies drive signals to the drive electrodes. Other tracks 14 provide sense connections for coupling controller 12 to sense electrodes of touch sensor 10, through which the sense unit of controller 12 senses charge at the capacitive nodes of touch sensor 10. In certain embodiments, tracks 14 are made of fine lines of metal or other conductive material. As an example and not by way of limitation, the conductive material of tracks 14 are copper or copper-based and have a width of approximately 100 μm or less. As another example, the conductive material of tracks 14 are silver or silver-based and have a width of approximately 100 μm or less. In particular embodiments, tracks 14 are made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, certain embodiments of touch sensor 10 include one or more ground lines terminating at a ground connector (similar to a connection pad 16) at an edge of the substrate of touch sensor 10 (similar to tracks 14).

In certain embodiments, connection pads 16 are located along one or more edges of the substrate, outside the touch-sensitive area(s) of touch sensor 10. As described above, controller 12 is on an FPC in certain embodiments. In some embodiments, connection pads 16 are made of the same material as tracks 14 and are bonded to the FPC using an anisotropic conductive film (ACF). In certain embodiments, connection 18 includes conductive lines on the FPC coupling controller 12 to connection pads 16, in turn coupling controller 12 to tracks 14 and to the drive or sense electrodes of touch sensor 10. In another embodiment, connection pads 160 are inserted into an electro-mechanical connector (such as a zero insertion force wire-to-board connector); in this embodiment, connection 180 does not need to include an FPC. This disclosure contemplates any suitable connection 18 between controller 12 and touch sensor 10.

FIG. 2 illustrates an example device 20 that utilizes touch sensor 10 of FIG. 1. Device 20 includes any personal digital assistant, cellular telephone, smartphone, tablet computer, and the like. In certain embodiments, device 20 includes other applications such as automatic teller machines (ATMs), home appliances, personal computers, and any other such device having a touchscreen. For example, a certain embodiment of device 20 is a smartphone that includes a touchscreen display 22 occupying a significant portion of the largest surface of the device. In certain embodiments, the large size of touchscreen display 22 enables the touchscreen display 22 to present a wide variety of data, including a keyboard, a numeric keypad, program or application icons, and various other interfaces as desired. In certain embodiments, a user interacts with device 20 by touching touchscreen display 22 with a stylus, a finger, or any other appropriate object in order to interact with device 20 (i.e., select a program for execution or to type a letter on a keyboard displayed on the touchscreen display 22). In certain embodiments, a user interacts with device 20 using multiple touches to perform various operations, such as to zoom in or zoom out when viewing a document or image. In some embodiments, such as home appliances, touchscreen display 22 does not change or changes only slightly during device operation, and recognizes only single touches.

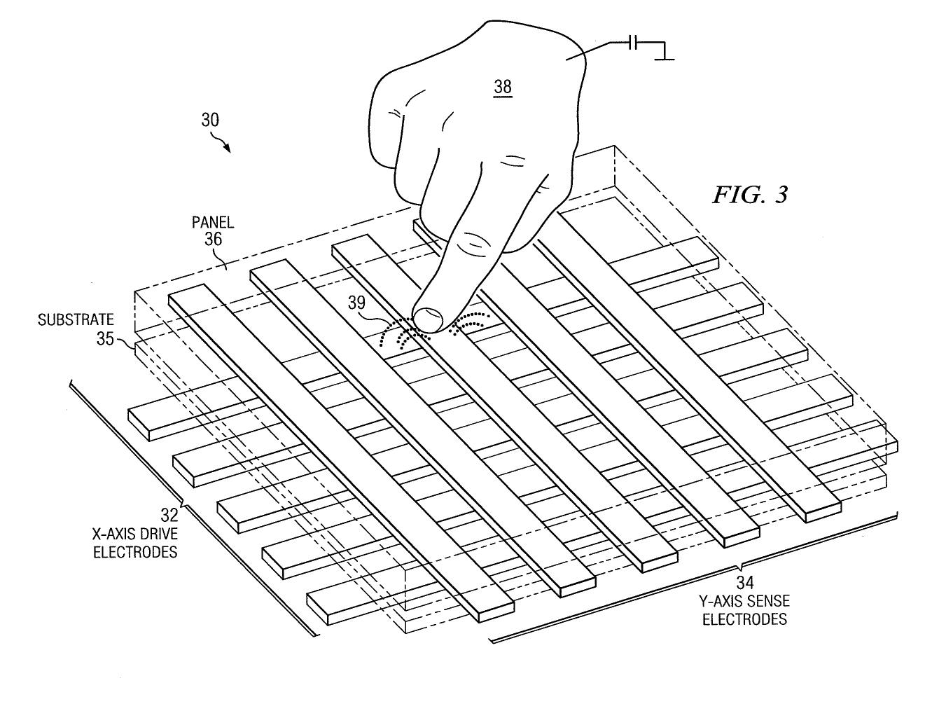

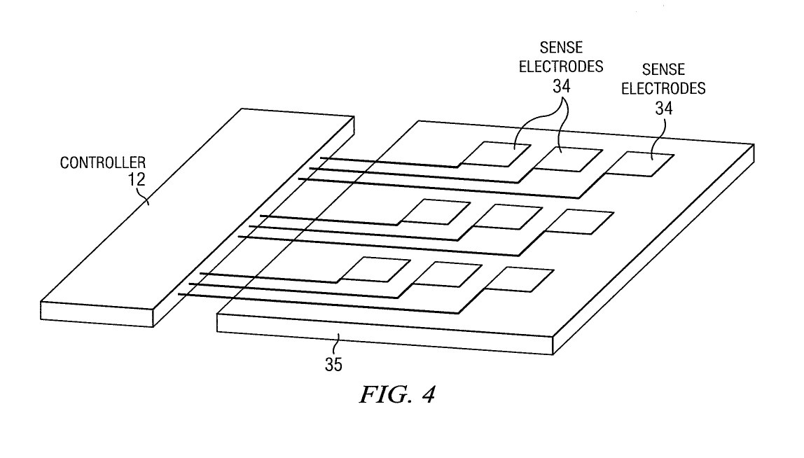

FIG. 3 illustrates a touch sensor 30 that may be utilized as touch sensor 10 of FIG. 1. Touch sensor 30 includes drive electrodes 32, sense electrodes 34, a substrate 35, and a panel 36. In some embodiments, panel 36 is a transparent panel. In other embodiments, panel 36 is not transparent. In some embodiments, substrate 35 is sandwiched between drive electrodes 32 and sense electrodes 34, and sense electrodes 34 are coupled to an underside of panel 36 with, for example, an adhesive. In other embodiments, touch sensor 30 includes any appropriate configuration and number of layers of electrodes and substrates. For example, some embodiments of touch sensor 30 include additional layers of sense electrodes 32 that run perpendicular (or any other appropriate angle) to sense electrodes 34.

In certain embodiments, electrodes 32 and 34 are configured in a manner substantially similar to the drive and sense electrodes, respectively, described above with reference to FIG. 1, and touch object 38 is capacitively coupled to ground. In certain embodiments, touch sensor 30 determines the location of touch object 38 at least in part by using controller 12 to apply a pulsed a or alternating voltage to drive electrodes 32, which induces a charge on sense electrodes 34. When touch object 38 touches or comes within proximity of an active area of touch sensor 30, a change in capacitance may occur, as depicted by electric field lines 39 in FIG. 3. The change in capacitance is sensed by sense electrodes 34 and measured by controller 12. By measuring changes in capacitance throughout an array of sense electrodes 34, controller 12 determines the position of the touch or proximity within the touch-sensitive area(s) of touch sensor 30.

FIG. 4 illustrates a self-capacitance embodiment of touch sensor 10. In a self-capacitance implementation, touch sensor 10 may include an array of electrodes of a single type that may each form a capacitive node. When an object touches or comes within proximity of the capacitive node, a change in self-capacitance may occur at the capacitive node and controller 12 may measure the change in capacitance, for example, as a change in the amount of charge needed to raise the voltage at the capacitive node by a pre-determined amount. As with a mutual-capacitance implementation, by measuring changes in capacitance throughout the array, controller 12 may determine the position of the touch or proximity within the touch-sensitive area(s) of touch sensor 10. This disclosure contemplates any suitable form of capacitive touch sensing, where appropriate.

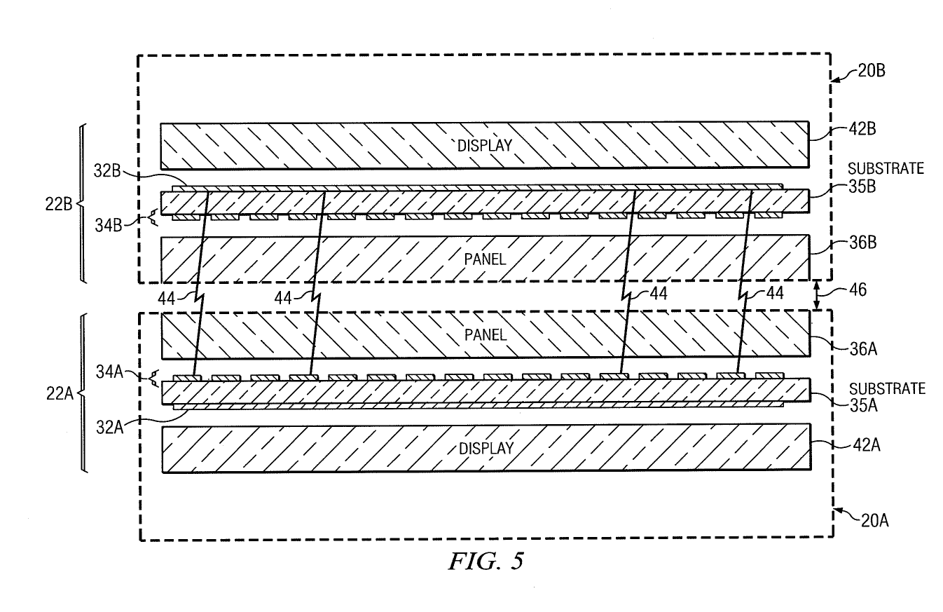

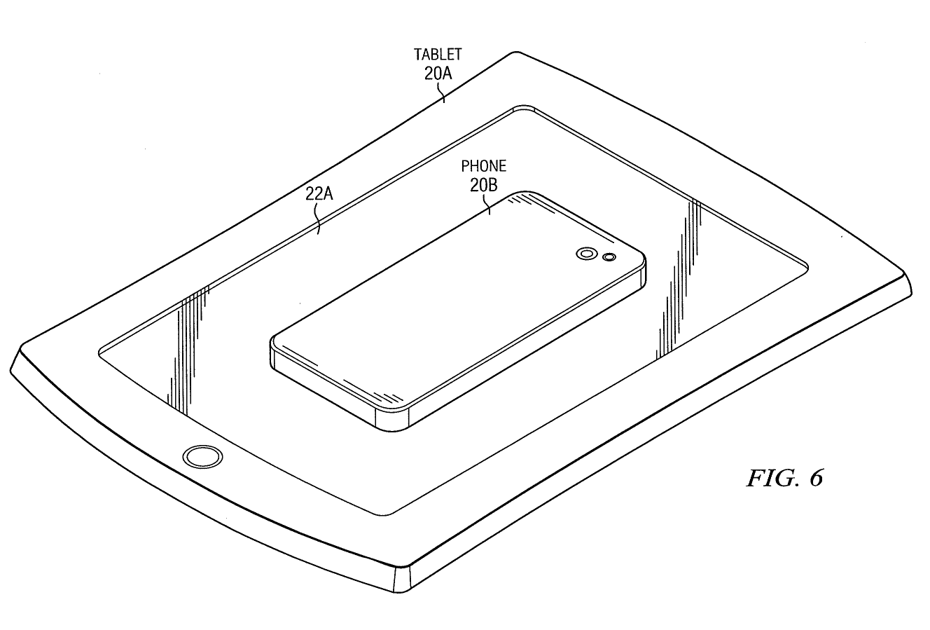

As discussed above, devices that have touch sensors typically transmit and receive data using a dedicated transceiver or data cable. For example, a device may utilize a Wi-Fi transceiver or may be coupled to another computer system via a cable (i.e., a Universal Serial Bus (USB) cable) in order to transmit or receive data such as an electronic file. Embodiments of device 20 utilizing touch sensor 30, however, provide advantages over typical devices by utilizing electrodes 32 and 34 to communicate, as described in more detail below with reference to FIGS. 5 and 6. As a result, embodiments of touch sensor 30 provide cost and weight savings to device 20 because they provide communications capabilities without the need for additional dedicated transceivers, data ports, or cable drivers. In addition, embodiments of touch sensor 30 provide users of device 20 with an easier and intuitive method of transferring data to and from device 20.

FIGS. 5 and 6 illustrate example embodiments of device 20 utilizing touch sensor 30 to communicate. FIG. 5 illustrates a side view of two devices, device 20A and device 20B, positioned in a manner so that panels 36A and 36B are facing each other. As an example for illustrative purposes only, device 20A is a tablet computer and device 20B is a smartphone, as illustrated in the perspective view of FIG. 6. The disclosure anticipates, however, devices 20A and 20B being any appropriate devices utilizing touch sensor 30.

As illustrated in FIG. 5, devices 20A and 20B include drive electrodes 32A and 32B, sense electrodes 34A and 34B, substrates 35A and 35B, panels 36A and 36B, and displays 42A and 42B, respectively. To communicate, devices 20A and 20B are placed in close proximity to each other with panels 36A and 36B facing each other. Gap 46 between panels 36A and 36B may be any appropriate distance that allows sense electrodes 34 of one device 20 to detect capacitance changes due to the pulsing of drive electrodes 32 of another device 20. In certain embodiments, the extent of gap 46 is zero (e.g., panel 36B of device 20B is contacting panel 36A of device 20A.) For example, device 20B may be placed directly on top of device 20A as illustrated in FIG. 6.

Display 36 may be any appropriate device for displaying content to a user of device 20. In certain embodiments, display 36 is any appropriate active or passive display such as a liquid crystal display (LCD), a light-emitting diode displays (LED), an organic light-emitting diode (OLED), or any other existing or future display technology. Display 36 displays content to the user including any appropriate application running on any appropriate operating system.

In operation, devices 20 communicate with each other using drive electrodes 32 and sense electrodes 34. As discussed above, a pulsed or alternating voltage may be applied to drive electrodes 32 (i.e., by controller 12) in order to induce a charge on sense electrodes 34. When an object touches or comes within proximity of the intersection of a drive electrode 32 and a sense electrode 34, a change in capacitance occurs at that intersection node, and controller 12 measures that change in capacitance. Embodiments of touch sensor 30 utilize drive electrodes 32 and sense electrodes 34 in a similar way for communications. More specifically, device 20B, which is in close proximity to device 20A, encodes data to be transmitted into any appropriate communications protocol. Device 20B then pulses its drive electrodes 32B (e.g., alternates between applying energy to drive electrodes 32B and not applying energy to drive electrodes 32B) at a certain rate according to the communications protocol in order to induce pulsed charges (as depicted by electric field lines 44) on sense electrodes 34A of device 20A. Touch sensor 30 of device 20A measures the pulsed changes in the amount of induced charge using sense electrodes 34A, and decodes the pulsed changes according to the communications protocol. In a similar manner, device 20A pulses its drive electrodes 32A at a certain rate according to the communications protocol in order to induce pulsed charges on sense electrodes 34B of device 20B. Touch sensor 30b of device 20B measures the pulsed changes in the amount of induced charge using sense electrodes 34B, and decodes the pulsed changes according to the communications protocol. In this manner, devices 20A and 20B communicate data to each other using drive electrodes 32 and sense electrodes 34.

In some embodiments, device 20 periodically listens for signals transmitted by another device 20. In the illustrated configuration of FIGS. 5 and 6, for example, touch sensor 30 of tablet 20A periodically listens for signals transmitted by touch sensor 30 of smartphone 20B. For example, certain embodiments of touch sensor 30 of tablet 20A periodically listen for signals from touch sensor 30 of smartphone 20B by listening for and attempting to detect capacitance changes at sense electrodes 34A while drive electrodes 32A are inactive. In some embodiments, electrodes 32A are deactivated by controller 12 of tablet 20A. As used herein, “deactivated” or “inactive” refers to no voltage being applied to drive electrodes 32.

In some embodiments, device 20 periodically listens for a synchronization signal transmitted by another device 20. For example, many communications protocols have a “heartbeat” or a “beacon” signal that is transmitted at periodic intervals to alert other devices within range of their presence. As another example, many communications protocols have one or more frames of fixed data that are used to initialize a communications session (i.e., a “handshake”). Embodiments of touch sensor 30 periodically listen, as described above, for a synchronization signal being transmitted by another touch sensor 30. In some embodiments, for example, touch sensor 30 is preprogrammed to listen at periodic intervals for specific patterns of capacitance pulses detected by sense electrodes 34. Once the specific pattern of capacitance pulses (i.e., the synchronization signal) is detected by touch sensor 30, certain embodiments of touch sensor 30 attempt to establish a communications session with the other touch sensor 30 by, for example, transmitting signals using its drive electrodes 32.

In some embodiments, touch sensor 30 periodically listens for signals transmitted by another touch sensor 30 at all times. That is, some embodiments of touch sensor 30 analyze all capacitance changes detected by sense electrodes 34 in order to look for a synchronization signal transmitted by another touch sensor 30. In other embodiments, touch sensor 30 of a device 20 first determines whether a user is interacting with the device 20 before periodically listening for signals transmitted by another device 20. For example, one embodiment of touch sensor 30 communicates with software (i.e., an operating system or other program) running on device 20 in order to determine whether a user is currently interacting with device 20. As another example, some embodiments of touch sensor 30 determine whether a user is interacting with device 20 by determining whether sense electrodes 34 have sensed any change in capacitance within a predetermined period of time. In certain embodiments, if touch sensor 30 determines that a user is not currently interacting with device 20 (i.e., sense electrodes 34 have not sensed any change in capacitance in a predetermined period of time), certain embodiments of touch sensor 30 deactivate drive electrodes 32 for a predetermined amount of time at a predetermined interval in order to listen for signals transmitted by another touch sensor 30. In certain embodiments, this deactivation can occur irrespective of user interaction. In certain embodiments, the system can have a user-activated listening period, in which a user of device 20 provides a user input to put the device into listening mode. Once in listening mode, the device will wait for a predetermined amount of time for a synchronization signal. If a synchronization signal is received before the end of the predetermined amount of time, synchronization occurs; otherwise, the device will exit listening mode.

In certain embodiments, touch sensor 30 of a first device 20 determines whether a second device 20 has been placed on or in close proximity to the first device 20. For example, certain embodiments of tablet 20A determine whether another device 20 such as smartphone 20B has been placed on touchscreen display 22 of tablet 20A or in close enough proximity to tablet 20A for sense electrodes 34A to detect capacitance changes caused by drive electrodes 32B. In certain embodiments, touch sensor 30 of a first device 20 determines whether another device 20 has been placed on or near the first device 20 by analyzing the shape of capacitance changes detected by sense electrodes 34. For example, as described above, drive electrodes 32 and sense electrodes 34 visually intersect each other (but do not physically contact each other), forming an array of capacitive nodes across touch sensor 30. By determining which capacitive nodes detected changes in capacitance, touch sensor 30 is able to determine a location on touchscreen display 22 that was touched by touch object 38. In a similar manner, touch sensor 30 of device 20A utilizes the capacitive nodes formed by drive electrodes 32A and sense electrodes 34A to determine whether device 20B has been placed on device 20A. For example, certain embodiments of device 20A analyze capacitance changes detected by multiple capacitance nodes and determine that the nodes that detected the capacitance change form a specific shape such as a square, a rectangle, and the like. As illustrated in FIG. 6, for example, some embodiments of tablet 20A determine that nodes that detected the capacitance change form a rectangle that matches the shape of smartphone 20B. After determining that device 20B has been placed on or in close proximity to device 20A, certain embodiments of touch sensor 30 of tablet 20A then listen for a synchronization signal from touch sensor 30 of device 20B and/or initiate a communications session with touch sensor 30 of device 20B.

In some embodiments, touch sensor 30 of device 20A utilizes other methods to determine whether device 20B has been placed on or near device 20A. For example, certain embodiments of touch sensor 30 of device 20A detect the synchronization signal transmitted by the touch sensor 30 of device 20B. Certain other embodiments of touch sensor 30 detect a wireless signal transmitted by a transceiver of device 20B. In some embodiments, this includes a signal from a radio-frequency identification (RFID) transceiver, a Wi-Fi transceiver, a cellular telephone transceiver, and the like. In some embodiments, device 20A includes a button (i.e., a hard button on the exterior of device 20A or a soft button displayed on touchscreen display 22) that a user may press in order to indicate that device 20B has been placed on device 20A. The disclosure anticipates any appropriate method of determining whether device 20B has been placed on or in close proximity to device 20A.

In some embodiments, touch sensor 30 employs various security measures to control or restrict communications with other touch sensors 30. For example, certain embodiments of touch sensor 30 establish a secure communications session with another touch sensor 30. The secure communications session may include any appropriate secure and/or encrypted communications protocol. In some embodiments, touch sensor 30 of device 20A validates device 20B as an authorized device before communicating data with the touch sensor 30 of device 20B. For example, certain embodiments of touch sensor 30 of device 20A access a list stored in memory (i.e., a database) that is accessible to touch sensor 30. The list may include any appropriate identifier of authorized devices in which device 20A may communicate. For example, some embodiments of the list include serial numbers, user IDs, model numbers, or any other appropriate identifier of authorized devices. Once touch sensor 30 of device 20A has validated device 20B as an authorized device, it establishes (or continues establishing) a communications session with touch sensor 30 of device 20B. If touch sensor 30 of device 20A does not validate device 20B as an authorized device (i.e., an identifier of device 20B is not found in the list), it does not establish (or discontinues establishing) the communications session with device 20B.

In some embodiments, a self-capacitance touch sensor 30 communicates with another self-capacitance touch sensor 30. In yet other embodiments, a self-capacitance touch sensor 30 communicates with a mutual-capacitance touch sensor 30. In embodiments involving a self-capacitance touch sensor, the electrodes of only a single type are used both to transmit signals and detect capacitance changes.

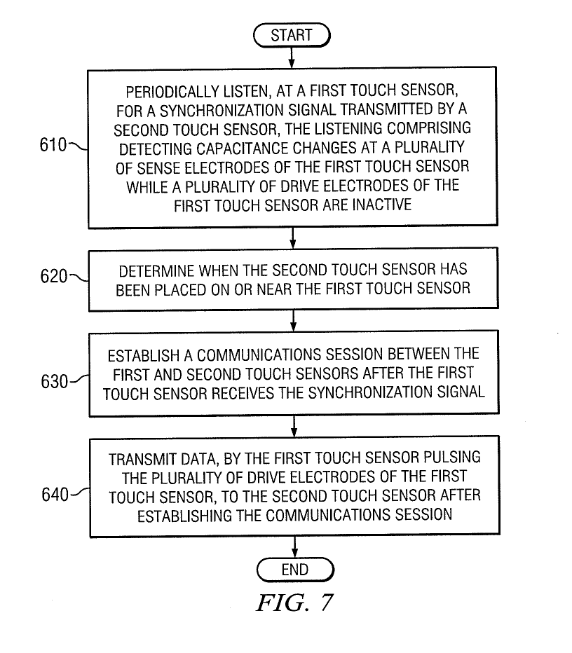

FIG. 7 illustrates an example method 600 that is used in certain embodiments for communications between touch sensors. Method 600 begins in step 610 where a first touch sensor periodically listens for a synchronization signal transmitted by a second touch sensor. In some embodiments, the listening of step 610 includes detecting capacitance changes at a plurality of sense electrodes of the first touch sensor while a plurality of drive electrodes of the first touch sensor are inactive. In some embodiments, the first touch sensor of step 610 refers to touch sensor 30 described above. In some embodiments, the first touch sensor is included in a touch-sensitive device such as device 20 described above. In certain embodiments, the plurality of sense electrodes refers to sense electrodes 34 and the plurality of drive electrodes refers to drive electrodes 32 described above.

In certain embodiments, the periodic listening for a synchronization signal of step 610 is performed at all times by the first touch sensor. In other embodiments, the periodic listening for a synchronization signal of step 610 is performed after the first touch sensor determines that a user is not currently interacting with the first touch sensor. For example, certain embodiments of the first touch sensor determine that a user is not interacting with the first touch sensor if the first touch sensor does not detect any capacitance changes with the plurality of sense electrodes within a predetermined amount of time.

In step 620, the first touch sensor of step 610 determines whether a second touch sensor has been placed on or near the first touch sensor. In some embodiments, the first touch sensor determines whether a second touch sensor has been placed on or near the first touch sensor by receiving a synchronization signal from the second touch sensor. In certain other embodiments, the first touch sensor determines whether a second touch sensor has been placed on or near the first touch sensor by other methods such as determining a shape of capacitive nodes of the first touch sensor that detected capacitance changes. In some embodiments, for example, if the capacitive nodes form a specific shape such as a rectangle or a square, the first touch sensor determines that a second touch sensor has been placed on or near the first touch sensor. In some embodiments, the first touch sensor determines whether a second touch sensor has been placed on or near the first touch sensor by determining whether a button has been pressed on the device in which the first touch sensor is located.

In step 630, a communications session is established with the second touch sensor after receiving the synchronization signal. In certain embodiments, the communications session is a secure communications session. In some embodiments, the communications session is established after the second touch sensor is validated by the first touch sensor. In some embodiments, establishing the communications session includes performing a handshake routine.

In step 640, data is transmitted by the first touch sensor to the second touch sensor by the pulsing of the plurality of drive electrodes of the first touch sensor. In some embodiments, the data is transmitted to the second touch sensor after the communications session is established in step 630. In some embodiments, the data refers to an electronic file. After step 640, method 600 ends.

Accordingly, example embodiments disclosed herein provide a touch sensor that is capable of communicating data with another touch sensor and thus provide numerous advantages over typical touch sensors. For example, devices utilizing embodiments of the disclosed touch sensor may cost less to design and manufacture, may consume less power, and may weigh less due to the devices not needing dedicated transceivers for data communications. Furthermore, devices utilizing embodiments of the disclosed touch sensor may provide a more user-friendly method of transferring data to and from the device because users may transfer data simply by placing one device on or near another device. Accordingly, embodiments of the disclosure provide numerous enhancements over typical touch sensors.

Although the preceding examples given here generally rely on self capacitance or mutual capacitance to operate, other embodiments of the invention will use other technologies, including other capacitance measures, resistance, or other such sense technologies.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A touch sensor comprising:
a substrate;
a plurality of touch electrodes coupled to the substrate;
a controller communicatively coupled to the plurality of touch electrodes, the controller operable to communicate with a second touch sensor by:
periodically listening for a synchronization signal transmitted by the second touch sensor, the listening comprising detecting capacitance changes at one or more of the plurality of touch electrodes;
establishing a communications session with the second touch sensor after receiving the synchronization signal; and
transmitting data, using one or more of the plurality of touch electrodes, to the second touch sensor after establishing the communications session.

2. The touch sensor of claim 1, wherein the touch sensor is a self-capacitance touch sensor.

3. The touch sensor of claim 1, wherein:
the touch sensor is a mutual-capacitance touch sensor; and
the plurality of touch electrodes comprises a plurality of sense electrodes and a plurality of drive electrodes.

4. The touch sensor of claim 3, wherein transmitting the data comprises pulsing one or more of the plurality of drive electrodes.

5. The touch sensor of claim 3, the controller further operable to receive data from the second touch sensor after establishing the communications session by:
setting the plurality of drive electrodes to be inactive; and
detecting capacitance changes at the plurality of sense electrodes, the capacitance changes caused by pulsing of drive electrodes of the second touch sensor.

6. A touch-sensitive device comprising a controller, the controller communicatively coupled to a plurality of touch electrodes, the controller operable to communicate with a second touch-sensitive device by:
listening for a synchronization signal transmitted by the second touch-sensitive device, the listening comprising detecting capacitance changes at one or more of the plurality of touch electrodes;
establishing a communications session with the second touch-sensitive device after receiving the synchronization signal; and
transmitting data, using one or more of the plurality of touch electrodes, to the second touch-sensitive device after establishing the communications session.

7. The touch-sensitive device of claim 6, wherein the touch-sensitive device is a self-capacitance touch sensor.

8. The touch-sensitive device of claim 6, wherein:
the touch sensor is mutual-capacitance touch sensor; and
the plurality of touch electrodes comprises a plurality of sense electrodes and a plurality of drive electrodes.

9. The touch-sensitive device of claim 8, the controller further operable to receive data from the second touch-sensitive device after establishing the communications session by:
setting the plurality of drive electrodes to be inactive; and
detecting capacitance changes at the plurality of sense electrodes, the capacitance changes caused by pulsing of drive electrodes of the second touch-sensitive device.

10. The touch-sensitive device of claim 5, the listening for the synchronization signal comprising periodically listening for the synchronization signal after determining that a user has not interacted with the touch-sensitive device for a predetermined amount of time.

11. The touch-sensitive device of claim 5, the controller further operable to receive an electronic file from the second touch-sensitive device after establishing the communications session.

12. The touch-sensitive device of claim 5 further comprising a panel, the controller further operable to determine whether the second touch-sensitive device has been placed on the panel.

13. The touch-sensitive device of claim 5, wherein the communications session comprises a secure communications session.

14. The touch-sensitive device of claim 5, the controller further operable to validate the second touch-sensitive device as an authorized device.

15. A method of communicating between a first touch sensor and a second touch sensor, the method comprising:
listening, by the first touch sensor, for a synchronization signal transmitted by the second touch sensor, the listening comprising detecting capacitance changes at one or more of a plurality of touch electrodes of the first touch sensor;
establishing a communications session between the first and second touch sensors after the first touch sensor receives the synchronization signal; and
transmitting data, using one or more of the touch electrodes of the first touch sensor, to the second touch sensor after establishing the communications session.

16. The method of claim 15, wherein the first touch sensor is a self-capacitance touch sensor.

17. The method of claim 15, wherein:
the first touch sensor is a mutual-capacitance touch sensor; and
the plurality of touch electrodes comprises a plurality of sense electrodes and a plurality of drive electrodes.

18. The method of claim 17 further comprising receiving data from the second touch sensor at the first touch sensor after establishing the communications session by:
setting the plurality of drive electrodes of the first touch sensor to be inactive; and
detecting capacitance changes at one or more of the plurality of sense electrodes of the first touch sensor, the capacitance changes caused by pulsing of drive electrodes of the second touch sensor.

19. The method of claim 15, the listening for the synchronization signal comprising periodically listening for the synchronization signal after determining, by the first touch sensor, that a user has not interacted with the first touch sensor for a predetermined amount of time.

20. The method of claim 17, wherein transmitting the data comprises pulsing one or more of the plurality of drive electrodes.
